(19) United States
(12) Patent Application Publication
(10) Pub. No.: US 2004/0158871 A1
(43) Pub. Date: Aug. 12, 2004

(54) Automated digital media vending apparatus

(75) Inventor: Greg Jacobson, Santa Monica, CA (US)

Correspondence Address: DAVIDSON, DAVIDSON & KAPPEL, LLC, 485 SEVENTH AVENUE, 14TH FLOOR, NEW YORK, NY, 10018, US

(73) Assignee: Bulldog Investments, LP, Santa Monica, CA

(21) Appl. No.: 10/771,219

(22) Filed: Feb. 3, 2004

Related U.S. Application Data
(60) Provisional application No. 60/445,133, filed on Feb. 4, 2003.

(51) Int. Cl. H04N 7/173; H04N 7/16

(52) U.S. Cl. 725/115; 725/145; 725/92

(57) ABSTRACT

A system and apparatus for legally copying and dispensing music, video games, feature movies and other multimedia onto blank digital media (such as disks, e.g., CDs or DVDs) from a local source inside the apparatus or from a remote source accessible via a data line. The system receives and transmits multimedia updates from a remote information source, and transmits transaction information to a remote server that supports and compiles data for an entire network of apparatuses, while respecting copyright royalty requirements and viewer restrictions based upon age. The system provides for the rental (as well as the physical and electronic return of disks) and sale of disks, and each apparatus may prepare its own inventory by recording media titles onto blank disks. The apparatus verifies the age of the user prior to dispensing certain age-restricted media titles.

### BACKGROUND OF THE INVENTION

1. Field of the Invention

This invention relates to the field of sale and/or rental of digital or optical multimedia. More particularly, this invention relates to apparatus for creating and providing to consumers digital or optical disks or other portable media for sale or rental, based upon digital and other multimedia data from a local or remote information source.

2. Description of the Prior Art

There have been several attempts in the prior art to create an apparatus that provides to consumers selected digital or optical disks for sale, based upon digital and other multimedia data that is provided from a local or remote information source.

U.S. Pat. No. 5,523,551 to Scott, entitled Vending Apparatus and System for Automated Dispensing of Disks, discloses a vending apparatus and system for storing and automatically dispensing magnetic or optical disks. A user interface allows a user to enter a dispensing request corresponding to the selection of a desired disk and receives user identification information, such as credit or debit card information or other magnetically stored information. Once a disk selection has been entered and user identification information has been received and verified, the selected disk is dispensed from the vending unit. The dispensed disks may have a region of magnetic recording media formed on one surface, and the vending unit may write information relevant to the transaction onto the region of magnetic media.

U.S. Pat. No. 5,633,839 to Alexander et al., entitled Music Vending Machine Capable of Recording a Customer's Music Selections onto a Compact Disc, discloses a compact disk (CD) vending machine having a monitor that displays a list of available musical selections digitally stored in a removable hard drive and a list of the customer's selections. The customer uses a keyboard to provide input to the microprocessor, which acts upon instructions received from a random access memory and a read only memory. The hard drive stores data in the random access memory and retrieves data from the random access memory as directed by the microprocessor. A card reader retrieves electronic information from a payment card and sends payment information to the microprocessor. A CD writer and dispenser that are controlled by the microprocessor retrieve a blank CD from storage, record the customer's musical selections onto the CD, and dispense the CD.

U.S. Pat. No. 5,740,134 to Peterson, entitled Musical CD Creation Unit, discloses an apparatus for providing both review and recording functions for the automated merchandising of music on recordable CDs. The apparatus includes a CD jukebox that stores musical selections, a computer terminal having a display monitor and input means that allows a customer to review and create a musical selection to be reproduced on a recordable CD, and a CD recorder for recording the user's selections onto a recordable CD. The apparatus also includes an audio output reviewing device to enable a user to listen to his digital musical selections and a purchase feature including a magnetic card reader for credit cards and a currency changer for cash to enable a customer to purchase the recordable CD on site.

U.S. Pat. No. 5,949,688 to Montoya et al., entitled Compact Disc Recorder/Vending Machine, discloses a CD vending system that allows a purchaser to compile a set of musical selections and record them onto a CD and to customize the jacket of the CD with a desired graphic. A data source contains information to be recorded onto the CD, and a viewing computer allows the user to watch and listen to available titles in the data source prior to making a selection. An ordering computer enables the user to place his or her order by entering its title or catalog number and any other information that may be required for the production of the CD via a keyboard or the like, and has a storage device containing information on available selections. The data source could be an internal high capacity data storage system or CD jukebox or could be part of an outside host system that is accessed using a high speed modem. The apparatus also has a payment slot for accepting cash or credit cards, a CD recording unit for preparing the CDs, and a printing unit for preparing the CD cover according to the user's taste.

U.S. Pat. Nos. 5,905,797 and 6,104,813 to McRae, both entitled Interactive Compact Disc System, disclose a system for controlling the playing of rented compact discs on an end-user's compact disc player. The end-user obtains a validation disc on which is stored a control program and an expiry date and which, when inserted into the user's player, causes the player to download the control program into its memory and run the program, causing the expiration date to be read from the disc and stored in the player's memory. Discs have stored thereon a second control program that is downloaded into the player's memory when inserted into the player, causing the player to check whether or not the current date, as maintained by the player, is earlier than the stored expiry date. If the current date is later, playing of the disc is prevented; if the current date is earlier, playing of the disc is allowed.

None of these prior art systems, however, provides for creation of a disk for the consumer purely for temporary use and return, i.e., for rental use, and none of these apparatus provides a mechanism for return of the disk after the rental period.

None of these prior art systems provides the consumer, prior to dispensing the disk containing the selected media, with a choice of purchasing or renting the disk, and none of these apparatus provides for changing, after the disk has already been dispensed, the initially chosen purchase or rental nature of the transaction.

Also, none of these prior art systems provides an apparatus that, prior to dispensing the disk, provides measures, either onto the disk media or onto the disk itself, to prevent the disk from being copied and from being used past the specified rental period.

In addition, none of these prior art systems provides an apparatus that, prior to dispensing a disk containing the selected media, verifies the consumer's age for compliance with the age restrictions of the consumer's selected media.

None of these prior art systems provides an apparatus that is capable of physically stocking and replenishing popular media titles based upon demographic information data stored, either locally or remotely, collected at least in part from historical purchases or rentals from that or a similarly situated apparatus.

Further, none of these prior art systems accounts for royalty payments owed to media rights holders as a result of the copying, purchasing or renting of disks containing the various media.

Still further, none of these prior art systems provides a system that is capable of linking one or more of such apparatuses to a network for sharing data and information relating to customers, transactions, demographics, usage and returns.

Even further still, none of these prior art systems provides a system that is capable of being accessed by a consumer remotely via a data network, e.g., the internet, for selection of the media to be created and for designation of the specific apparatus where pickup of the disk having the selected media is desired.

### SUMMARY OF THE INVENTION

Accordingly, it is an object of the present invention to provide an apparatus that provides to a consumer, either from physical stock inventory or by copying from a remote or local data source, a disk bearing media and data that has been selected by the consumer and paid for by a credit card transaction, and to provide this disk to the consumer either for sale or for purely temporary use, the inventory for rental or sale preferably being established either prior to the customer's selection or upon the customer's selection.

It is another object of the present invention to provide an apparatus that provides to a consumer a time limit for disk rentals, allows subsequent physical return of the disk within the rental period, and allows the consumer the ability to change, at any time after sale/rental, the initial sale/rental choice that was made by the consumer when accepting the disk.

It is yet another object of the present invention to provide an apparatus that, prior to dispensing a disk, provides measures, either onto the disk media or onto the disk itself, to prevent the disk from being copied and/or from being used past the specified rental period.

It is still another object of the present invention to provide an apparatus that, prior to dispensing a disk containing the selected media, verifies the consumer's age for compliance with the age restrictions of the consumer's selected media, whether voluntary or mandatory.

It is a further object of the present invention to provide an apparatus that is capable of physically stocking popular media titles based upon demographic information data stored, either locally or remotely, and collected at least in part from historical purchases or rentals from that or a similarly situated apparatus.

It is a further object of the present invention to provide an apparatus that is capable of replenishing physical inventory within the apparatus without human intervention by creating new disks as needed from stored data.

It is still a further object of the present invention to provide a system that is capable of linking one or more of such apparatuses to a network for sharing data and information relating to customers, transactions, demographics, usage and returns, and that accounts for royalty payments owed to media rights holders as a result of the copying, purchasing or renting of disks containing the various media on all apparatuses across the system.

It is yet a further object of the present invention to provide such a system that is capable of being accessed by a consumer remotely via a data network, e.g., the internet, for selection of the media to be created and for designation of the specific apparatus where pickup of the disk having the selected media is desired.

In accordance with these and other objects of the invention, the present invention is a system and apparatus for distribution, i.e., sale and/or rental, to a consumer of digital or optical data, such as music, movies, games or other multimedia data (collectively referred to as “titles” or “data”) on disks or other portable media, preferably digital or optical disks, typically digital versatile or video disks (DVDs) or compact disks (CDs) (hereinafter collectively simply “disks”). The system preferably comprises a central operating unit that supports a network of one or more apparatuses and compiles data for the entire network. Each apparatus provides blank disks from physical storage and legally copies data to the disks, while respecting copyright royalty requirements, protecting against further copying using some form of encryption or other copy protection, and respecting viewer restrictions based upon age. The system provides for physical or electronic return of disks by a consumer in the event of a rental.

Typically, using an apparatus within the system of the present invention, the customer selects, preferably via an input device, a particular title to purchase or rent, and the apparatus verifies the availability of the title and the age of the customer, as may be required for certain multimedia data, and accepts payment from the customer, either by cash or credit card. The apparatus then prepares the disk and delivers the finished product to the consumer via a dispensing slot, either unpackaged or packaged, perhaps in a package designed by the customer at the apparatus. The apparatus has the capacity to dispense the disk from a local physical storage unit or to immediately copy the requested data either from at least one hard drive data source inside the apparatus or from a remote data source. The inventory inside the local physical storage unit for rental or sale is preferably established prior to the customer's selection and preferably by the apparatus itself, such as either from at least one hard drive data source inside the apparatus or from a remote data source. A local microprocessor in communication with a remote server receives from the remote server any updates with regard to available titles and transmits to the remote server specific customer and transaction information.

In a preferred embodiment, each apparatus unit comprises a housing, which is typically approximately the size of a free standing automated teller machine (ATM), and which comprises a previewing monitor (display screen) and/or an ordering screen, an input or selection device such as a keyboard and/or a menu or icon driven catalog software, a mechanized unit for dispensing disks, a mechanized unit for accepting the return of disks, a receipt dispenser for providing receipts to the user, a card reader, e.g., magnetic, for accepting input of information (such as payment information and identity and age verification information) from the user, an optional second card reader for verification of the user's age and identity, and an optional hard currency payment acceptance device for input of bills and coins. The apparatus also contains at least one microprocessor or central processing unit, at least one local hard drive or data source unit, at least one mechanism for producing the disks (such as a high speed disk writer and/or copier), a unit for writing and dispensing receipts, at least one disk storage unit, a data modem, internet connection or other data source line connection, and an optional mechanism for packaging the disks. The apparatus also comprises proprietary software to manage each step of the process.

It is preferred that each apparatus be networked to other apparatuses as part of a larger system, and that the transactions within each apparatus be tracked by the network and be fed to a central operating unit in order to allow for control of system-wide returns of disks, to account for proper and accurate royalty payments to rights holders, and to allow for dynamic updating of inventory based upon historical and demographic data and projected sales and rentals.

The data source unit stores information, preferably in the form of digital data, to be recorded onto the disk. The previewing monitor will provide access to available selections via a menu/icon driven catalog software and will, in some embodiments, allow the user to watch or listen to samples of available media titles before making a selection. The ordering screen accesses a hard drive or other storage device containing information pertaining to the available title selections, and enables the user to place an order via the input device for the production of the disk. The previewing monitor and ordering screen are preferably interconnected, allowing the previewing monitor access to selection information located on the storage device of the ordering screen.

In one preferred embodiment of the present invention, the apparatus has a storage unit for physically storing in inventory a large number of disks bearing currently-popular titles. In this embodiment, the apparatus will be able to store popular titles in order to avoid any wait time by the consumer. Thus, when a user requests to rent or purchase one of these titles, the apparatus will be able to immediately fill the user's order with one of the disks in inventory within the storage unit of the apparatus.

In one embodiment, the specific titles that are stored within a particular apparatus are determined not randomly but rather with some relation to the titles that are likely to be popular with the residents of the neighborhood of the particular apparatus. In one embodiment, the specifically stocked titles will be chosen by the system, preferably by the central operating unit, based upon a mathematical model of titles that have historically been popular at that apparatus, at other apparatuses at nearby locations, and at other apparatuses at other locations with similar ethnic makeup. For new titles for which there is not yet any available “popularity” data, the system will predict titles that will be popular at a particular apparatus at a certain location based upon titles that have in the past been popular at that apparatus, at other apparatus at nearby locations, and at other apparatus at other locations with similar ethnic makeup.

In another embodiment, the inventory of titles stored within the apparatus is more limited, and the apparatus will physically carry only one copy of each title but may also digitally store the titles on a local hard drive within the apparatus or at a remote but immediately accessible storage location, such that an additional copy of a requested title will be prepared immediately once the sole stored disk for that title has been dispensed. In another embodiment, all titles will be stored only digitally, on a local hard drive within the apparatus or at a remote but immediately accessible storage location, and copies will be made for users on demand. In a preferred embodiment, the disk vending apparatus may also comprise more than one disk burner for copying multiple selections at one time, a disk reader for validating returned disks, and a disk eraser or rewriter that makes disks available for re-use, preferably by writing over or erasing data written thereon.

In a further preferred embodiment, the apparatus is able to offer for sale or rent more titles than are currently available in inventory within its hard drive or physical storage unit. In this embodiment, if a user requests to purchase or rent a title that is not currently within inventory, the apparatus will immediately, preferably via an electronic connection, such as the internet, obtain that requested title from the central processing unit or from an outside source, and replicate the title onto a disk within the apparatus for immediate sale or rent to the requesting user. The apparatus will also store that title within the apparatus on the local hard drive and thereby, at the same time, update its own inventory based upon the release of new titles and upon changes in consumer demand locally or regionally. Furthermore, the apparatus will also be able to update and restock its own physical inventory as needed using data stored either locally or remotely.

In a preferred embodiment, the system may accept ordering instructions from consumers via the internet, and such disks may be retrieved at an apparatus at a location of the customer's choice. Furthermore, in a networked system, the user may be able to purchase or rent a disk at one apparatus location and return it to another apparatus location within the system.

In a preferred embodiment, the system provides the purchaser with the option either to rent or to purchase the disk, a choice that may be made by the user either before or after the disk has been dispensed. The system also provides the capability for automated return of the disks, by permitting the user to return a rented disk electronically, physically to any apparatus in the network, or via U.S. mail with a return mailer provided at the outset. Wherein the disk is physically returned to an apparatus, a reader in the apparatus processes the return immediately and provides instant verification and a receipt for the return. In a further embodiment, the apparatus “clears” the disk and allows it to be recycled into the pool of blank disks for future use. If a consumer fails to return the video within the prescribed period agreed to at time of rental then the transaction is deemed a purchase and no return is required or accepted.

In yet another preferred embodiment, as part of the disk writing process, the system assigns a unique serial number to each disk for use in tracking, returns, accounting, etc. This unique serial number will also provide the apparatus with a means for accounting for each of the blank disks by comparing each blank disk inserted with the total number of disks recorded and dispensed so that content providers may “audit” each machine to verify that royalties were properly calculated for every disk that was dispensed by or returned to the apparatus.

In still another preferred embodiment, rented disks will be encrypted, marked electronically or treated chemically at the time of rental, so as to prevent them from being used past the rental period by rendering the rented disks useless after the conclusion of the rental period. The electronic marking with an expiration date causes a rented disk, when played on a device that can read such electronically marked dates and are programmed to not perform playback functions for such disks, to be rendered useless after the conclusion of the rental period. Chemical treatment causes a treated disk to physically deteriorate or to be otherwise rendered unreadable over a pre-set rental time period.

In one embodiment, the monitor or touch screen provides an advertising medium to the consumer by offering previews of available movies, video games and other content, as well as advertisements for those and other products, that may play in a predetermined loop until interrupted by user interface. Using the monitor or touch screen, users will be able to access “trailers” or pre-packaged advertisements provided by the producers of the titles or independent advertisers. In a further embodiment, the system will add onto each disk, based upon demographic information, specific advertisements or previews of other movies, music, games or other data, while that disk is being prepared and the apparatus will choose the most targeted advertisements for each customer based upon the demographic information.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 is an external hardware diagram for one embodiment of an apparatus according to the present invention;

FIG. 2 is a block diagram for one embodiment of an apparatus architecture and operation process according to the present invention; and

FIG. 3 is a block diagram for one embodiment of a system architecture according to the present invention.

### DETAILED DESCRIPTION OF THE INVENTION

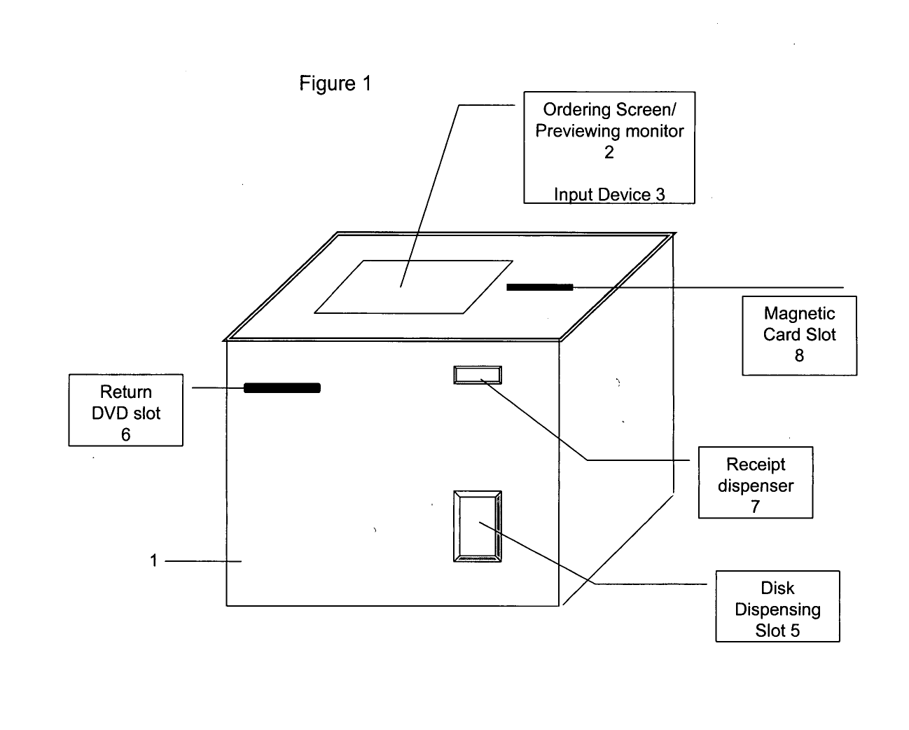

The present invention is a system and apparatus for distribution, i.e., sale or rental, of selectively recorded optical or digital compact disks (“CDs”), digital versatile or video disks (“DVDs”), data or software disks, etc. or other portable media (hereinafter collectively referred to as “disks”). FIG. 1 illustrates one preferred embodiment of the outside appearance of the vending apparatus. The apparatus of the present invention comprises a unit housing 1 and is typically approximately the size of a free standing automated teller machine (ATM). The apparatus housing 1 preferably comprises the following items, as viewable from the outside the apparatus, a previewing monitor and/or an ordering screen 2, an input or selection device 3, a slot or tray 5 for dispensing of disks, a slot 6 for return of disks, a receipt dispenser 7 for providing paper receipts to the user, at least one slot 8 for accepting input of information (such as payment information or age and identity verification) from the user via cards, e.g., magnetic cards, and potentially a hard currency payment slot (not shown).

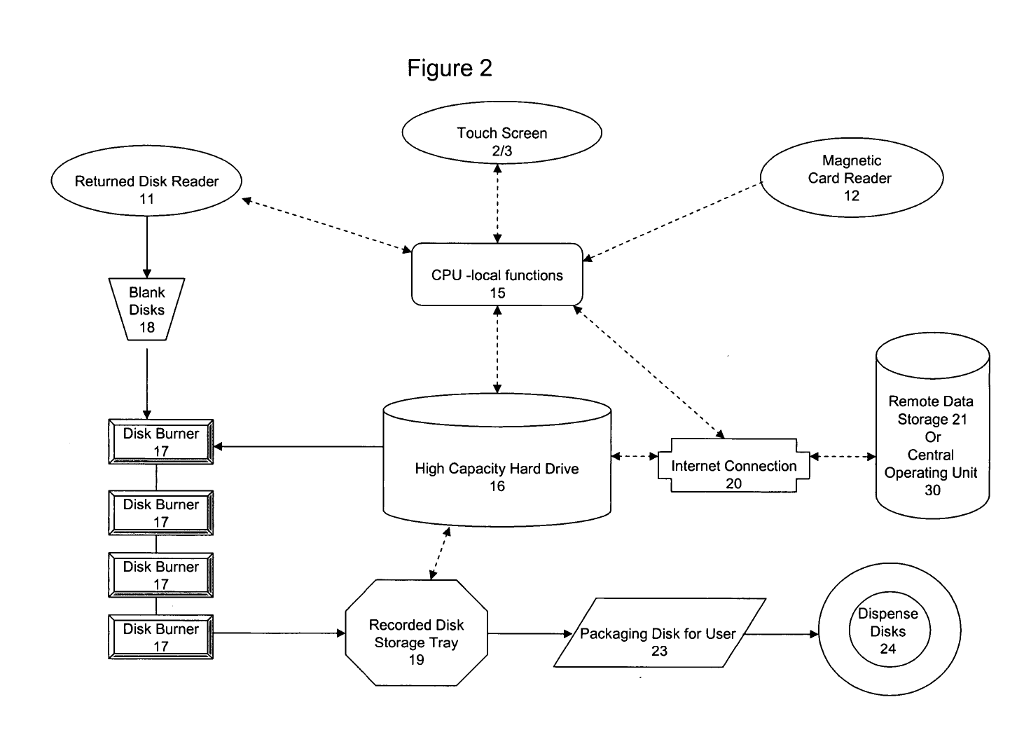

In addition, in preferred embodiments, as further shown in part in FIG. 2, provided internally of the apparatus are a mechanized unit 24 for dispensing disks that is adjacent to the external slot or tray for dispensing of disks, a mechanized unit 11 for accepting the return of disks that is adjacent to the external slot 6 for return of disks, a printing unit (not shown) for preparing receipts and other printed information that is adjacent to the external receipt dispenser 7, and at least one magnetic or digital card reader 12 for reading information such as payment or identity verification information from the users' cards that is adjacent to the external slot 8 for accepting input of information from the user via cards, and an optional hard currency payment processing device for input (and providing change of) of bills and coins that is adjacent to an optional external hard currency payment slot. Such mechanized elements are well known in the art and need no specific detailed description here.

The apparatus preferably also contains at least one microprocessor or central processing unit 15 that utilizes proprietary software to manage each step of the disk ordering, copying, rental or sale payment, dispensing, royalty accounting and replenishment process. The apparatus preferably further contains at least one local hard drive or data source unit 16, at least one mechanism 17 for producing (recording or copying) the disks (such as a high speed disk writer and/or copier, often known as a disk “burner”), at least one physical disk storage unit (one 18 for blank disks and one 19 for disks containing media titles), a data source line connection 20 such as data modem, internet connection or other data connection, a mechanism 23 for packaging the disks, including a printing unit for printing indicia (words or graphics) on the surface of the disks and/or packaging. Such elements are also well known in the art and need no specific detailed description here.

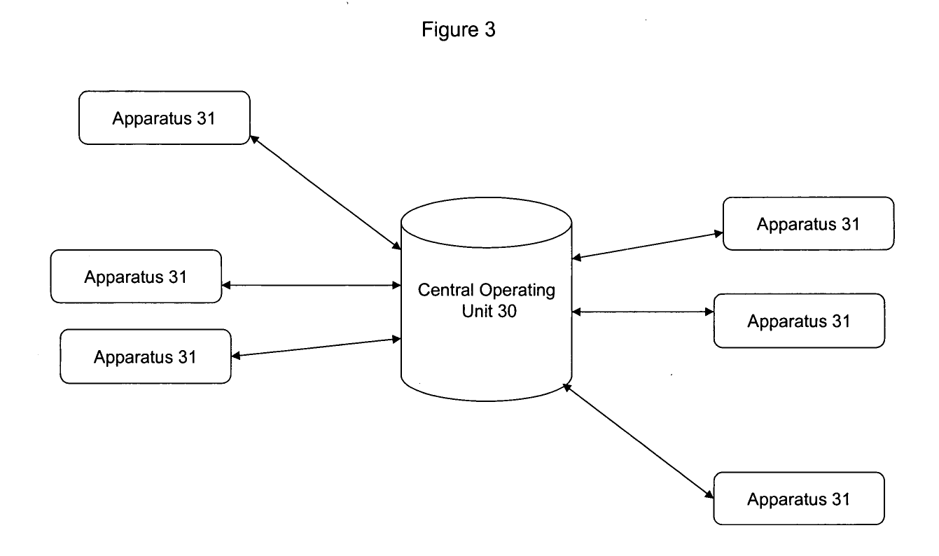

In a preferred embodiment, as shown in FIG. 3, each apparatus 31 is independently connected as part of a larger network of other apparatuses to a central operating unit. The central operating unit 30 preferably has data storage capacity for accepting and storing information such as data regarding the titles dispensed, customer identity information, transaction information, demographic information, royalty information, etc., at least some of which may be provided by the apparatuses 31. The central operating unit 30 preferably also contains software in order to analyze, manage and collate this information, and preferably determines trends in rental or purchase of titles in specific geographic regions and determines payment of appropriate royalties based upon sales or rentals of the titles. The central operating unit 30 preferably also provides fraud warnings in cases of suspected identity theft. Furthermore, the central operating unit 30 preferably also contains memory storage of all the possible titles, i.e., digital information and data, that may be requested by a user of any apparatus 31, which are typically licensed from the title holders for distribution, and a means of communicating such data to any apparatus 31 that has a need for such information.

Typically, a customer who desires to purchase or rent a disk with a desired title makes a selection of a particular title via the input device 3. The apparatus then verifies the availability of the title and the age of the customer, as may be required for certain multimedia data, accepts payment, by either cash or credit card, prepares the disk, allows for personalized packaging of the disk, and delivers the finished product, either packaged or not, to the consumer via a dispensing slot or tray 5.

The ordering screen 2 enables the user to place an order via the menu and/or icon driven catalog software for the production of the disk. The ordering screen 2 functions as the vehicle by which the apparatus CPU 15 communicates with the user during the selection process, such as by providing the user with a choice of available titles to select, displaying the user's current selections and requesting further information. The ordering screen 2 accesses a local hard drive 16 or other storage device containing information pertaining to the available selections. The apparatus may list the available titles in a specific order, e.g., alphabetically, or may allow the user to search the desired title from a menu, organized, for example, by name, genre, author, producer, actors/singer, etc. The apparatus may also advise the user of the titles that are physically available and those that must be copied (and that may thus require slightly greater waiting time).

The previewing monitor 2, also referred to as a display screen, provides the user with visual access to previews of all available titles via a menu and/or icon driven catalog software, as well as promotions and advertisements, in order to allow the user to watch or listen to selected title samples before making a selection. In a preferred embodiment, the previewing monitor and ordering screen are interconnected, allowing the previewing monitor access to selection information located on the storage device of ordering screen. In a further preferred embodiment of the invention, the previewing monitor and the ordering screen are merged into one screen 2 that has the functions of both.

The input or selection device 3 is utilized when the user inputs titles that are selected for production. The input device 3 may be a keyboard, a mouse, a microphone for use with voice recognition software, a touch screen or any other such device. In certain preferred embodiments, the keyboard may be included within the ordering screen 2, preferably as part of a state of the art touch screen, thus resulting in an easier and more user friendly system.

In this invention, card readers 12 in the apparatus serve at least two purposes integral to the process: to accept payment from the user and to verify the identity and age of the user. The apparatus will preferably have at least one and perhaps two such card readers 12 to perform these functions, and these readers should be capable of reading data stored on cards, e.g., magnetically, digitally, electronically or in any other manner. With regard to payment, the apparatus of the present invention will, in preferred embodiments, have a card reader 12 to accept from the user payment for the dispensed disk with a credit or debit card, as do many electronic devices nowadays. The apparatus will also internally comprise the hardware necessary to accomplish this purpose, such as a device to communicate with the company or bank that issued the user's credit card for approval of the charge.

With regard to identity and age verification, in one preferred embodiment, the system will use data on the user's credit card and/or driver's license, for example via the card's magnetic strip or microprocessor chip, to identify the user and verify that the user is of legal age to rent or purchase the title that he/she has chosen. In the instance of the driver's license, once the user inserts the card into slot 8, the verification of the user's identity is almost instant, as the majority of states now issue driver's licenses with magnetic data that includes birth date information. In the instance of the credit card, the system will prompt the user to answer certain questions that will allow the system to match information provided by the user with information contained in a proprietary identity database in order to verify the customer's identity without the need for further identification. Once a credit card is known to be that of an adult, no further identification or authentication may be required for future uses of that card.

In situations wherein a user does not have identification that is obtainable from a card that is magnetically or otherwise readable, the user may be permitted to enter a code into the input device, either keyboard or touch screen, that will be provided by an attendant who verifies the user's age, wherever such an attendant can be made available.

In one preferred embodiment of the present invention, the apparatus is equipped with at least one local physical storage unit for storing in inventory a large number of disks bearing currently-popular titles 19. Preferably, this disk storage unit 19 is of the jukebox type. In this embodiment, the apparatus will have the capability to inventory popular titles in order to avoid any wait time for the consumer. Thus, when a user requests to rent or purchase a title in stock, the apparatus will be able to immediately fill the user's order with one of the disks in inventory within the physical disk storage unit 19 of the apparatus.

The storage capacity of the physical storage unit 19 is not unlimited, however, and each apparatus is able to physically stock only certain titles. In one embodiment, the specific titles that are stored within a particular apparatus are determined not randomly but rather with some relation to the titles that are likely to be popular with the residents of the neighborhood of that particular apparatus. In a preferred embodiment, if the apparatus is not connected to a system, the apparatus's CPU 15 chooses the specific titles that are to be stocked, and if the apparatus 31 is connected as part of a system, either the apparatus's CPU 15 or the system's central operating unit 30 chooses the specific titles that are to be stocked, the choice of titles to be stocked being made preferably using a statistical, mathematical or analytical model that determines the titles that have had the greatest box office success, and/or historically been requested at the greatest frequency at the apparatus at that location, at other apparatus within the same neighborhood, and at other apparatus within other neighborhoods that have similar ethnic makeup and that the system demonstrates have similar tastes in titles.

For new titles or for an apparatus in a neighborhood for which there is not yet any available “previously requested” data, the apparatus's CPU 15 or the system's central operating unit 30 will arrange for the apparatus to be stocked with titles that are predicted to be popular at a particular apparatus within a certain neighborhood based upon titles that have in the past been popular at that apparatus at that location, at other apparatus within the same neighborhood, and at other apparatus within other neighborhoods that have similar ethnic makeup and that the system demonstrates have similar tastes in titles as well as box office results for the various titles.

Once a title has been removed from the physical storage unit 19, it is important that the dispensed disk 24 be replaced within the apparatus in order for the same title to be available to other users for sale or rent. In a first embodiment of the invention, the apparatus has no capacity to self-replace the dispensed titles and depends upon administrators to physically stock the apparatus with the titles to be dispensed, including replacement of the titles previously dispensed. In this embodiment, the apparatus keeps a log of the titles dispensed and periodically forwards this to an administrator of the apparatus or to the central system, for restocking of the apparatus, including physical replacement the dispensed title, if necessary. In a preferred embodiment, the apparatus will contain in stock 19 more than one copy of the most frequently requested titles so that the stock of the popular titles within the apparatus is not depleted.

The apparatus is also designed to allow the location manager (in some instances, a joint venture partner or franchisee or reseller) to manufacture disks for subsequent resale or rental in off hours with a master private label access card, so that additional inventory may be established by the retailer at his discretion. This will allow a retailer to stock additional depth of titles and to order titles in advance for customers to pick up upon their arrival. It is further anticipated that the apparatus will be designed to inventory additional copies of certain titles in order to facilitate new releases and unusual spikes in popularity, and in order to provide additional inventory in conjunction with promotional efforts by the retailer, the title producer or the apparatus owner. Such additional inventory may be established independently of, or in conjunction with, the statistical analysis and inventory planning discussed above.

In a more preferred embodiment of the invention, the apparatus is equipped with at least one additional local physical storage unit 18 for storing in inventory a large number of blank disks as well as at least one disk recorder or burner 17, as discussed above and further below. In this embodiment, the apparatus has the capacity to self-replace the dispensed titles by recording additional copies of those titles onto blank disks within the apparatus. A title that is in inventory is immediately delivered to the consumer through the dispensing slot 5 when selected, without having to be recorded first, and the apparatus will then record that selection onto a blank disk in order to replace in inventory the one selected by the customer.

Thus, in this embodiment, when a user requests to rent or purchase a title in stock, the apparatus fills the user's order with one of the disks in inventory within the physical disk storage unit 19 of the apparatus. At a convenient time later, perhaps during downtime of the apparatus, the apparatus replaces the title of the dispensed disk under the control of the CPU. The apparatus removes a blank disk from one of the blank disk storage locations 18, places it into a recorder unit 17, copies from the data storage unit 16 the data corresponding to the title on the previously dispensed disk, and delivers the finished product into the open inventory slot in storage 19 that was created when the dispensed disk was removed. In a more preferred embodiment, the apparatus may produce multiple disks simultaneously.

In preferred embodiments, the inventory of titles stored within the apparatus will be even more limited than previously discussed. In this embodiment, the apparatus will carry only few copies, perhaps as few as one copy, of each title but will also digitally store the titles on a local hard drive 16 within the apparatus, such that additional copies of a requested title will be prepared immediately once the stored copies of the disk for that title have been dispensed, as discussed above. It is preferred, in this embodiment as well as in all other embodiments, that the local hard drive 16 will have as much data storage capacity as possible, in order that it may store as many titles and other information locally as possible.

It is preferred that, not only will the apparatus prepare a replacement disk for dispensed disks, but the apparatus will also use artificial intelligence and statistics regarding the demand and sales performance of the various titles to continually adjust inventory based upon anticipated future sales. In particular, in order to allocate internal physical storage space for various titles, the CPU 15 and/or the networked system's central operating unit 31 will consider the historical performance of specific titles, as well as the historical performance of certain genres of titles, such as those that have historically been requested with the greatest frequency at the apparatus at that location, at other apparatus within the same neighborhood, and at other apparatus within other neighborhoods that have similar ethnic makeup and that the system demonstrates have similar tastes in titles.

The determination of which titles are most likely to be selected by future users and the resulting adjustment of the inventory accordingly depends upon an analytical methodology and specific software for allocating current sales and rental statistics on a national, regional and local level, as well as the demographic information of the apparatus' current location (including actual retail location, neighborhood, etc). Inventory of each specific apparatus within the system of apparatuses will, therefore, be adjusted based upon past performance of the specific titles in that apparatus, availability of newly released items, the demographics of the immediate area surrounding the apparatus itself, sales patterns for other apparatuses in similar markets, seasonality, the actors, writers and directors of titles that may have been more or less popular with other works, and any other item from which it can be reasonably established that demand may increase or decrease for specific titles at specific locations.

It is preferred that the management of this process will take two forms. In a system embodiment, the apparatus will feed its sales information to a host computer, such as the central operating unit 30 for the system, which will analyze the statistics for each individual apparatus 31, as well as compare, contrast and/or compile those statistics with those of other apparatuses 31 in order to identify actual or potential trends. The central operating unit 30 will then instruct the apparatus 31 to adjust its inventory levels to reflect the newly established quantities. In response to this instruction, the apparatus 31 could adjust its inventory passively, by simply not replacing certain titles when those titles are dispensed from the apparatus, either for rent or sale, and by instead filling the empty slots within the apparatus with other titles to replace the titles dispensed. Alternatively, the apparatus could adjust its own inventory actively, by removing from the machine the inventory of titles to be replaced, such as those currently out of favor, and immediately replacing them with new inventory. In an alternative (system or non-system) embodiment, the apparatus 31 itself, without instruction from a host computer, or perhaps as connected to other computers that may pass or provide to the apparatus certain information regarding meaningful sales statistics, is programmed to adjust its own inventory and requires no instruction from a host computer, or receives such instruction from another apparatus or device besides a host computer.

In a further embodiment, using the same or similar statistical information that is used to vary inventory, the apparatus or network of apparatuses may also vary the sales or rental price of various titles so as to maximize revenue at the apparatus' point of sale. In other words, the most popular titles at that particular apparatus will also be the most expensive.

In a preferred embodiment, the apparatus has minimal physical disk storage space 19 for prepared disks and will preferably not hold any disks in inventory. Instead, the data for various titles are digitally stored only on a local hard drive or data storage unit 16 within the apparatus, and physical disks of titles selected by users are prepared for users on demand, without physically ever having been in inventory. As technology advances and data storage capability is further increased, the local hard drive 16 will be able to store more data.

Current technology allows for the copying (referred to as “burning”) of disks at a speed of 8x, which is approximately eight times the normal play speed. Thus, for example, it currently may take up to 15 minutes to burn a two-hour long movie onto a DVD. In a most preferred embodiment of the invention, as disk burning times decrease due to advances in technology, the faster burn times (perhaps up to 48× or even greater) will completely eliminate the need for the apparatus to maintain an inventory of disks and will allow for ultra-fast, on-demand copying and disbursement of disks from the apparatus. In embodiments having burn times of somewhat greater than 8× and less than 48×, it is anticipated that some combination of storage of popular disk titles and on-site preparation of disk copies will be utilized.

Because a single computer may efficiently and effectively operate multiple disk burners, a preferred embodiment of the apparatus comprises one or more (perhaps up to six) mechanisms 17 for producing (recording or copying) the disks at high speed (often known as disk “burners”) so that multiple disks can be made simultaneously in order to provide for the timely replacement of inventory and efficient preparation of multiple titles as desired by the user.

While each apparatus will maintain many titles either in physical inventory 19 and/or resident in its local hard drive memory 15, there are countless titles that the apparatus will be unable to store, due to physical and digital space restraints. In order to facilitate unusual orders and provide customers with access to less popular titles, in a further embodiment of the invention, the apparatus is able to offer for sale or rent more titles than are currently available in inventory within its storage unit. In this embodiment, if a user requests to purchase or rent a title that is not currently within inventory, the apparatus will immediately, either via the internet or some other data link 20, obtain the data for that requested title from an outside data source 21, such as the central operating unit 30, store the data for that title on the local hard drive 15 of the apparatus 31, and replicate the title onto a disk within the apparatus for immediate sale or rent to the requesting user. The apparatus will thereby locate, at a remote location, certain titles that are not available in inventory or on hard disk and will then download them and record them to disk for a consumer upon request. Thus, at the same time as the apparatus provides the user with the requested title, the apparatus also updates its own inventory based upon the release of new titles and upon changes in consumer demand locally or regionally.

This process of obtaining the data from a remote source 21, storing it and then preparing a disk with that data may take a significant amount of time, depending upon the size of the file to be obtained, the speed of the data connection 20 with the data source 21 and the speed of the recording unit 17. In one embodiment, wherein the time for preparing the disk is relatively small, the downloading and recording may be done while the consumer waits or may be done in the background as the system is charging the customer and processing the order. In a preferred embodiment, the apparatus will provide the user with an estimate of the time for preparation of the disk, and, once the customer approves, the user's credit card will be charged. If the expected wait time is more than a specified time, the apparatus may also provide the user with the option of returning some short time later to retrieve the completed disk. The apparatus will provide a time after which the consumer may return for the finished product. When the user attempts to retrieve his disk, the apparatus will verify the identity of the user, preferably through the magnetic information on a credit card or a driver's license, and will dispense the prepared disk via the dispensing slot 5.

In a more preferred embodiment, as disk burn speeds increase and broad band internet access speeds increase, this waiting-and-return function will be unnecessary, and the apparatus will simply download the requested data immediately from the remote data source 21, preferably via the internet 20, and prepare the disk without delay.

In a preferred embodiment, the system uses specialized disk media that is manufactured on a custom basis. This specialized disk media is recordable, to allow the user's selections to be prepared as requested and, more preferably, to allow inventory within the apparatus to be established and replenished for subsequent sale or rental. Typically, disk media carries “flags” in the lead track area of the disk to identify the disk type either as recordable or as read-only, so that media players can ascertain the type of disk that is being inserted therein. Certain encryption algorithms are designed to not be used in conjunction with recordable media. To that end, DVD players read the lead track area and search for the flag that indicates whether the media inserted is in fact read-only or recordable. If the media is recordable, then the DVD player will not deploy its decryption software when reading that particular disk.

In this invention, the custom disk media will be manufactured to in fact be recordable, although the media is specifically marked as not recordable in the lead track area of the disk. The specific disk media will be flagged as non-recordable for the specific purpose of facilitating playback in the DVD players. This media, while inconsistent with the original intention of the standards for DVD that require clearly marking whether content is or is not recordable, is in compliance with the encryption standards and agreements. While such manufacture may be subject to the appropriate licensing of other patented technologies, the use of this specific resulting media and format in a vending machine is unique.

In another preferred embodiment of the invention, customers will be able to access the system via the internet and thereby order disks for pickup at the apparatus of their choice anywhere within the network. In this embodiment, the system has an accessible web presence through which a user may undertake the same steps that he would at a physical apparatus, i.e., select a disk title for purchase or rental and pay using a credit card. The user may also choose the apparatus site where he wishes to retrieve the chosen disk. If the chosen apparatus is unable, for whatever reason, to process the order and provide the chosen title, the user will be advised via internet, e.g., by reply e-mail. Otherwise, the system will process the order, and the apparatus will, as directed, download the title data as necessary from a remote location, prepare the disk with the selected title and then store the disk in an empty jukebox slot for the later pickup by the user. The apparatus may also provide the user via the internet with an electronic yet printable confirmation and provide a time that the user may retrieve his disk at that apparatus location.

When the user arrives at the designated apparatus and attempts to retrieve his disk, the apparatus will verify the identity and age of the user, preferably through magnetic information on a credit card or a driver's license swiped by the user, and will dispense the prepared disk to the user. This process is similar, regardless of whether the title ordered by the user is physically stored within the disk storage 19 of the apparatus, whether the data is stored within the local hard drive 16 of the apparatus, or whether the data is stored at some remote location 21, such as the central operating unit 30, and must be downloaded by the apparatus for copying onto a disk.

The apparatus will provide the user with a disk containing the requested selections. In preferred embodiments, the apparatus will dispense the disk to the consumer, preferably through a slot or receptacle, such as through slot 5. The apparatus is preferably provided internally with a mechanized unit 24 for dispensing disks adjacent to the external slot 5 for dispensing disks.

The disk may be provided to the customer as is, i.e., without a case, or in packaged form, such as in a hard or soft case made of paper, cardboard or plastic. Accordingly, the apparatus is also preferably provided internally with a mechanized unit 23 for packaging disks prior to being dispensed. The disk may be packaged, in a chosen package and with a chosen design, in accordance with a specific packaging chosen by the user during the ordering process.

The dispensing mechanism 24 will preferably also have the ability to provide or “imprint” information onto the disk prior to it being dispensed, such as information that would identify the customer who purchased/rented the disk and the details of the disk transaction, such as the contents of the disk, the date, time and location where the disk was dispensed. This information is used preferably in order to process payment by the customer for the appropriate purchase or rental, to ensure that the allotted rental time has not been exceeded, and to record accurate royalty information. In preferred embodiments, as discussed below, such information can be provided onto the disk in one of several known ways, such as magnetically or optically, e.g., as one of the “tracks” on the disk, as a serial number encrypted onto the disk or as a bar code on the disk itself.

In one preferred embodiment of the apparatus, each disk used by the apparatus will be uniquely marked so as to facilitate the identification and return of the disks. In a first embodiment, each apparatus within the system will utilize disks that have been manufactured with unique pre-recorded serial numbers. The disk manufacturers may mark the disks by any method known in the art, such as with any or all of the following; serial numbers on the disk in a form readable to the naked eye (in this case the number may be encoded), in the form of a bar-code on each disk (in the form of a standard bar-code or concentric circles), and by burning or stamping the serial number on each disk so that it can be read by an optical disk reader. By using this identification system, the system will be able to account for each disk by reading the individual number assigned to each disk and tracking the status of each disk, whether it is blank, recorded with a title, re-recorded, or otherwise accounted for. The ability of the system being able to verify the whereabouts of each disk purchased by the owners of the apparatus and verify via computer the eventual disposition of each disk is a key element of the system's proprietary nature as it allows content providers to effectively monitor the number of times their content is recorded onto the specialized media.

In certain preferred embodiments, the apparatus is able to provide disks to customers for rental, as opposed to solely for purchase. For example, at the time that the disk is dispensed to the user, the user is preferably provided with the choice of either renting or purchasing the disk. This decision can also be made by the user upon ordering the disk or at any time during the selection and ordering process, either physically at the apparatus or remotely, such as through an electronic connection, e.g., the internet. Typically, the apparatus will quote one price for rental of the disk, and a second, but higher, price for purchase of the disk, in either case with no obligation whatsoever to return the disk.

In a first embodiment wherein the apparatus is able to provide disks to customers for rental, the disk will simply be rendered unreadable after the rental period has elapsed, such that the user will be afforded the leisure of not having to return the rental disk and to simply discard it after the rental period, since it has been rendered unreadable anyway. This can be accomplished one of several ways known in the art. In one embodiment, each rental disk, prior to being dispensed, is encrypted or otherwise electronically marked with an expiration date that will cause the rented disk, when played on a device that can read such electronically marked dates and is programmed to not perform playback functions for expired disks, to be rendered useless after the conclusion of the rental period, such as disclosed for example in U.S. Pat. Nos. 5,905,797 and 6,104,813, to McRae. This marking or encryption prevents the disk from being read or from being played after that date and will thus limit the use period by the consumer. In this embodiment, the apparatus is preferably provided internally, adjacent to the external slot 5 for dispensing disks, with a mechanized unit for encrypting disks that will have the ability to encrypt the information on the disk prior to it being dispensed, such that the information becomes unreadable after the rental time period has elapsed. This encryption can also take place at the time of recording the information selected by the user onto the disk.

In another embodiment, each rental disk, subsequent to its creation and just prior to its being dispensed, will be treated with a nontoxic chemical that will render the disk unreadable after the rental period has elapsed. This can be done by several known ways, such as a chemical that will cause the disk to deteriorate or that will itself deteriorate or become opaque, and thereby block reading or playing of the disk, over a time period longer than a pre-agreed rental period. This chemical treatment may be similar to treatments that are used currently for disks as they are replicated, such as disclosed for example in U.S. Pat. No. 6,338,933 to Lawandy et al, U.S. Pat. No. 6,468,619 to Larroche, and U.S. Pat. Nos. 6,011,772, 6,343,063, 6,434,109 to Rollhaus et al., although in this case it is applied within the apparatus, after the digital content has been applied to the disk. In this embodiment, the apparatus is preferably provided internally, adjacent to the external slot for dispensing disks, with a mechanized unit for treating disks with the chemical.

In another preferred embodiment wherein the apparatus is able to provide disks to customers for rental, the system may be set up such that, if the user chooses to rent the disk, he must return the disk within a certain period of time, whereas if the user chooses to purchase the disk, he has no obligation whatsoever to return the disk. In this embodiment, the disks must be returned to the apparatus after the rental period, and the apparatus is provided with a slot or receptacle 6 for accepting the return of disks. This slot may be the same slot as the dispensing slot 5 or may be separate, such as slot 6. In such embodiments, the apparatus is also preferably provided internally with a mechanized unit 11 for accepting the return of dispensed disks adjacent to the external slot for accepting the return of dispensed disks. The accepting unit 11 will have the ability to read the information that was provided onto the disks prior to their being dispensed, so as to compare the present date with the rental expiration date in order to ensure that the allotted rental time has not been exceeded and to process the appropriate payment by the customer. The accepting unit will also have the ability to verify the integrity of the disk and that no damage was caused to the disk prior to its return.

In a preferred embodiment of a networked system, regardless of whether or where a disk was rented or purchased, any apparatus 31 within the system will be able to identify the disk as soon as it is introduced into the return slot of any other apparatus 31 within the system. The details of the transaction will be processed immediately and sent to the central operating unit 30 for validation, and the appropriate set of instructions will be transmitted to the customer via the touch screen user interface 2 of the apparatus 31 where the disk is returned. Thus, any disk can be returned to any apparatus location within the network, even if not the one from which the disk was dispensed. Because the inventory of each apparatus can be changed an infinite number of times, and disks that are returned may not actually be placed back into inventory at the return location, there are no limitations practical or otherwise with regard to a customer's ability to obtain a disk at one location and return it at another. In further embodiments, the system may allow disks be returned via U.S. mail to a central processing station, using a return mailer that was provided by the dispensing apparatus at the time of rental.

If a rental customer fails to return the disk within the prescribed time period agreed to at time of rental, the system may, in certain embodiments, deem the transaction to be a purchase of the disk, rather than a rental. The system will process the payment for complete purchase fee, and no return of the disk will be required or accepted. In other embodiments, failure to return a disk within the allotted time will result in a late charge being assessed and the rental period being automatically extended. This process of extending the rental process for late charges may be repeated until such time as the customer has been charged an amount in total equal to or greater than the original purchase price of the disk, at which point the customer will be deemed to have purchased the disk—no further charges will be made, the disk will be the customer's to keep (i.e., no further return of the disk will be required or accepted). Preferably, the entire purchase fee will have already been authorized at the time of disk creation. It is anticipated that the credit card used to pay for the transaction may be verified with the card provider multiple times or one time in an amount sufficient to guarantee payment of any possible costs. If the disk is returned within the allotted rental period, the return is validated, and the computer will create a “return” of the excess fee (or simply will not charge an additional fee) and provide a receipt to the consumer.

In another embodiment, the system will allow disks that were initially purchased to be returned as if they had been rented for only a pre-determined period of time. For example, if a user who purchased a disk changes his mind regarding the choice, the user may insert the disk into the return slot within any apparatus, and the apparatus will recognize the purchased disk in the return slot and will query the user as to his intention. Once the user advises the apparatus that he desires to return the disk, the apparatus will first verify that there has been no damage to the disk and will then accept the return of the disk as if it had been a rental from the outset. The apparatus will credit the user the difference between the purchase price and the rental price for the appropriate time that the disk had been used. Thus, the system is unique in that it allows a user to select a movie (while authorizing payment by credit card as if it is purchased or charging it in advance), take it home and view it, and then after having viewed it decide whether to keep it, or return it and only be charged for a rental.

In one embodiment of the invention, disks that are returned to an apparatus will merely be spooled for removal from the apparatus. For example, if chemical treatment has been used upon dispensing to render disks useless after a certain period of time, disks may be electronically processed at return but may not be recycled for reuse (although they may be recycled for re-use of materials).

In a preferred embodiment of the apparatus, disks that are returned to an apparatus may be recycled and re-used to create new disks for other users. In this embodiment, once a disk is returned to an apparatus, the apparatus “formats” or clears the disk and allows for its recycling into the pool of blank disks 18 for future use. For example, in an embodiment of the apparatus wherein encryption techniques are used to replace chemical treatment as a deterrent against unauthorized use, disks may be recycled, with the encryption being “wiped clean” off the disk. To that extent, it is envisioned that the return slot 6 will be integral to each of the generations of the instant invention. In this embodiment, the mechanized unit 11 for accepting the return of dispensed disks adjacent to the external slot 6 for accepting the return of dispensed disks will have the ability to reformat the disk so that new information may be recorded thereon for dispensing to a new customer.

It should be noted that the embodiment described above, wherein rental disks are treated with a nontoxic chemical prior to being dispensed in order to render the disk unreadable after the rental period, is not generally compatible with the embodiment wherein rental disks are returned to the apparatus, because generally the chemical with which the disk is treated prior to being dispensed prevents the disk from being reused. In this embodiment, therefore, consumers will be forced to decide at the time of dispensing and at the point of sale, instead of after viewing, whether to purchase or rent the disk, so as to avail themselves of this technology and thus avoid having to return the disk or avoid having it deteriorate in their possession.

In a further embodiment, it is contemplated that all disks will be able to be “returned” electronically via an electronic network, such as the internet. In this embodiment, software that can be accessed via the system's web site will be used to provide the system with access to the dispensed disks through a consumer's computer. A consumer will insert the rented disk into his computer after use and facilitate a “return” by following instructions available via the internet. The system's software will remotely disable the disk to prevent further access to the disk beyond the rental period. This will eliminate the need for physical returns and also provide for the possibility that disks originally intended to be rentals and electronically marked as such with expiration dates may be able to be modified in some future generation of the invention.

In yet a further embodiment of the invention, the system will provide users with an option for a subscription model. In this embodiment, a customer will pay a periodic, e.g., monthly, fee for unlimited use of the apparatus, and the customer will be allowed to retain or hold up to a specified number of disks for as long as desired without charge (other than the periodic subscription charge). Thus, the customer will be able to create and rent disks as often as desired. However, the customer will be permitted to use without returning only up to a specified number of disks, and may do so for as long as desired. The customer will also be permitted to use any system apparatus, at any location and at any time, to return disks, to rent new disks or to exchange current disks for new ones. In this embodiment, a customer's credit card will be authorized only for periodic fees, which may vary with the number of disks that the customer wishes to retain at once, regardless of how many disks have been created and rented.

As previously stated, and as shown in FIG. 3, each apparatus 31 will preferably be networked to a central operating unit 30. All rental and purchase activity will be monitored by the system and will be reported via an electronic data connection, such as an internet connection, to the central operating unit's remote server, which will have software designed to tally royalties due to owners of copyrighted data, maintain customer profile information, develop demographics for advertising, handle inventory management, maintain information regarding disk rentals and purchases, maintain system accounting and payments.

The system for electronically and physically marking each disk will be used to establish a system whereby copyright owners can verify that royalties were paid for all disks that were produced by each apparatus. Such a system will be able to provide each copyright owner with records of the serial numbers of all relevant disks produced and received by each apparatus, and will allow each owner of copyrighted material to verify to whom a royalty was paid for each disk created, and to verify which disks were destroyed and which disks remain in inventory. Thus, each apparatus may be “audited” to verify that royalties were properly calculated for every disk that was dispensed by and returned to the machine.

In one embodiment, the monitor or touch screen 2 will provide an advertising medium while the system is either (a) on standby or (b) completing a task that requires no interaction from the customer. In a preferred embodiment, the monitor or touch screen 2 will offer previews of available movies, video games and other content, as well as advertisements for those and other products, which may play in a predetermined loop until interrupted by the user interface. In another embodiment, the monitor or touch screen 2 will be able to access “trailers” or pre-packaged advertisements provided by the producers of the movies, producers of other media content or independent advertisers.

In a further embodiment, the system may add onto each disk customized paid advertising or specific advertisements or previews of other movies, music, games or other data, while the disk is being prepared for sale or rental to the user. The system will have the capability to select from a range of advertisements based upon a variety of criteria, and the advertisements will be stored on the hard drives Oust like movies) and downloaded as inventory is replenished in the machine or at the point of sale. The custom advertising applied to each disk may differ based upon demographic information, either in the aggregate or in the individual instance, such as the location of the machine, the title selected, and information regarding the user that is derived at least in part from the information on the user's driver's license and/or credit card and past rental history, and the apparatus will choose the most targeted advertisements for each customer based upon the demographic information.

In a preferred embodiment, the system will permit physical access to the apparatus by maintenance personnel in order to provide repairs and maintenance, such as to reload disks when necessary, clear jams and otherwise maintain the machine. In addition, the apparatus will preferably include sensors that detect specific maintenance or supply needs, such as a need for additional blank disks, ink or paper in the printer, or wrappers or other material for packaging the disks. The apparatus will preferably include other sensors to provide assistance in identifying malfunctions or jams, much like are used in most commercial photocopiers or vending equipment. Such sensors may take the form of sensors installed in the ink well or on the spool of blank disks or of other commercially available sensors that may be incorporated into the apparatus. It is contemplated that such sensors may take the form of optical devices, or other yet to be developed technology, that would be able to determine the remaining inventory of the necessary supplies in the machine.

In a preferred embodiment, the apparatus will also be able to send information or messages to the host computer (central operating unit) or the location manager, preferably through the internet, a Virtual Private Network or some other data line, regarding these maintenance needs or other possible supply considerations so that problems at an apparatus can be identified and repaired rapidly. It is also contemplated that this warning system will also be able to contact the appropriate personnel automatically via pager, cell phone or other electronic communications device.

Thus, an automated digital media vending apparatus has been provided. One skilled in the art will appreciate that the present invention can be practiced by other than the described embodiments, which are presented for purposes of illustration and not limitation.

What is claimed is:

1. An automated digital media vending apparatus, comprising:
a recording mechanism for recording selected media data titles onto blank disks;
a storage unit containing a plurality of stored disks bearing prerecorded media in the form of various data titles, at least some of which disks have been pre-recorded by the apparatus itself,
processing means for processing input from a user regarding said user and at least one selected data title;
a disk dispensing mechanism for removing a disk containing the selected data title from among said stored disks in said storage unit and for dispensing the disk containing the selected data title to the user;
a data memory for storing transaction information regarding at least the user, the selected data title, the specific disk containing the selected data title and the date on which the disk containing the selected data title was dispensed;
a disk accepting mechanism for accepting a disk inserted into said apparatus and for reading data from said inserted disk;
said processing means determining an appropriate payment from the user based upon the date on which the disk containing the selected data title was dispensed, whether the disk is inserted and, if the disk is inserted, the date on which the disk is inserted, and processing said appropriate payment from the user; and
if the disk is not inserted, said processing means determining whether said disk containing said selected data title must be replaced and, if so, directing said disk recording mechanism to record another disk containing said selected data title to replace in said storage unit the disk that was dispensed.

2. The apparatus of claim 1 further comprising an input device for accepting input from the user regarding a selected data title.

3. The apparatus of claim 2 wherein said input device is a keyboard, touch sensitive screen, microphone, a magnetic or digital card reader, or any combination thereof.

4. The apparatus of claim 1 further comprising a disk dispensing aperture proximate to said disk dispensing mechanism through which the disk containing the selected data title is dispensed to said user.

5. The apparatus of claim 1 further comprising a mechanism for packaging the disk containing the selected data title prior to the disk being dispensed to the user.

6. The apparatus of claim 5 wherein said processing means is adapted to process input from the user regarding desired packaging for the disk containing the selected data title.

7. The apparatus of claim 1 further comprising a disk accepting aperture proximate to said disk accepting mechanism through which the return into said apparatus of a previously-dispensed disk containing the selected data title is made.

8. The apparatus of claim 1, wherein said processing means, based upon transaction information associated with the dispensed disk containing the selected data title, charges the user a rental payment if the date on which the disk is inserted is within a preset time period from the date on which the disk was dispensed and charges the user a purchase payment if the disk is not inserted within the preset time period.

9. The apparatus of claim 8, wherein the user is provided with a choice prior to the disk being dispensed as to whether the disk is for sale or for rental.

10. The apparatus of claim 8, wherein the user is provided with a choice at the time the disk is being inserted into said apparatus as to whether the disk is for sale or for rental.

11. The apparatus of claim 1, wherein said processing means, based upon transaction information associated with the dispensed disk containing the selected data title, charges the user one payment if the date on which the disk is inserted is within a preset time period from the date on which the disk was dispensed and charges the user a second, higher payment if the date on which the disk is inserted is beyond the preset time period.

12. The apparatus of claim 1 wherein said processing means, based upon transaction information associated with the dispensed disk containing the selected data title, charges the user a first payment if the date on which the disk is inserted is within a first preset time period from the date on which the disk was dispensed, charges the user a second payment that is higher than the first payment if the date on which the disk is inserted is beyond the first preset time period but within a second preset time period from the date on which the disk was dispensed, and charges the user a third payment that is higher than the second payment if the date on which the disk is inserted is beyond the second preset time period.

13. The apparatus of claim 1 wherein each of said plurality of stored disks has a unique mark and is identifiable by said disk accepting mechanism using said unique mark, said disk accepting mechanism being adapted to read said unique mark from an inserted disk and to identify from said inserted disk the transaction information associated with said inserted disk.

14. The apparatus of claim 13, wherein said processing means, based upon transaction information associated with the inserted disk and the date on which the inserted disk is inserted, charges the user one payment if the date on which the disk is inserted is within a preset time period from the date on which the disk was dispensed and charges the user a second, higher payment if the date on which the disk is inserted is beyond the preset time period.

15. The apparatus of claim 13, wherein said processing means, based upon transaction information associated with the inserted disk and the date on which the inserted disk is inserted, charges the user a first payment if the date on which the disk is inserted is within a first preset time period from the date on which the disk was dispensed, charges the user a second payment that is higher than the first payment if the date on which the disk is inserted is beyond the first preset time period but within a second preset time period from the date on which the disk was dispensed, and charges the user a third payment that is higher than the second payment if the date on which the disk is inserted is beyond the second preset time period.

16. The apparatus of claim 13, wherein said unique mark comprises a unique serial number, bar code, encryption, or optical or digital marking.

17. The apparatus of claim 1, wherein said processing means, based upon transaction information associated with each dispensed disk and each inserted disk, calculates royalties due to rights-holders of each selected data title based at least upon the number of times a disk with that selected data title was dispensed from said apparatus.

18. The apparatus of claim 1, wherein each of said media data titles has a user age minimum limit associated therewith, such that it is desired that a user whose age is below said minimum limit not be dispensed a disk containing that selected data title, and said input from the user regarding said user includes the user's current age.

19. The apparatus of claim 16 further comprising an input device for accepting input from the user regarding the age of said user.

20. The apparatus of claim 19, wherein said input device is a magnetic or digital card reader.

21. The apparatus of claim 20, wherein said input device accepts reads information regarding the age of said user from magnetic or digital information on said user's driver's license.

22. The apparatus of claim 18, wherein said processing means, based upon user age minimum limit associated with said selected data title and said input from the user regarding the age of said user, determines whether dispensing of a disk containing said selected data title is permitted.

23. The apparatus of claim 1, wherein said processing means accesses transaction information from said data memory regarding at least the frequency of selection of the selected data title and determines, based upon the quantity of disks containing the selected data title in said storage unit, whether a disk containing the selected data title is needed to replace the disk containing the selected data title that was dispensed.

24. The apparatus of claim 1, further comprising a storage unit containing a plurality of blank disks and a disk formatting mechanism for erasing the selected data title from a dispensed disk, wherein the selected data title on said inserted disk is erased after said disk is inserted into said disk accepting mechanism, whereupon said inserted disk is placed back into said storage unit of blank disks.

25. The apparatus of claim 1, further comprising a storage unit containing a plurality of blank disks, wherein said processing means, in response to said input from a user regarding at least one selected data title, first determines if a disk containing said selected data title is present in said storage unit of prerecorded disks, wherein if so a disk containing said selected data title is dispensed to said user from said storage unit of prerecorded disks, and if not the selected data title is recorded by said disk recording mechanism onto a blank disk from said storage unit of blank disks and the newly-recorded disk containing the selected data title is then dispensed to the user.

26. A digital media vending system, comprising:
at least one automated digital media vending apparatus, comprising
a disk recording mechanism for recording selected media data titles onto blank disks;
a storage unit containing a plurality of stored disks bearing prerecorded media in the form of various data titles, at least some of which disks have been pre-recorded by the apparatus itself;
processing means for processing input from a user regarding at least one selected data title;
a disk dispensing mechanism for removing a disk containing the selected data title from among said stored disks in said storage unit and for dispensing the disk containing the selected data title to the user;
a data memory for storing transaction information regarding at least the user, the selected data title, the specific disk containing the selected data title and the date on which the disk containing the selected data title was dispensed;
a disk accepting mechanism for accepting a disk inserted into said apparatus and for reading data from said inserted disk;
said processing means determining an appropriate payment from the user based upon the date on which the disk containing the selected data title was dispensed, whether the disk is inserted and, if the disk is inserted, the date on which the disk is inserted, and processing said appropriate payment from the user; and
if the disk is not inserted, said processing means determining whether said disk containing said selected data title must be replaced and, if so, directing said disk recording mechanism to record another disk containing the selected data title to replace in said storage unit the disk that was dispensed;
a remote processing unit coupled to each of said at least one automated digital media disk vending apparatus such that transaction information can be passed between said remote processing unit and each said apparatus.

27. The system of claim 26, wherein said apparatus further comprises an input device for accepting input from the user regarding a selected data title.

28. The system of claim 26, wherein said input device is a keyboard, touch sensitive screen, microphone, a magnetic or digital card reader, or any combination thereof.

29. The system of claim 26, wherein said apparatus further comprises a disk dispensing aperture proximate to said disk dispensing mechanism through which the disk containing the selected data title is dispensed to said user.

30. The system of claim 26, wherein each said apparatus further comprises a disk accepting aperture proximate to said disk accepting mechanism through which the return into said apparatus of a previously-dispensed disk containing the selected data title is made.

31. The system of claim 26, wherein each of said plurality of stored disks has a unique mark and is identifiable by a disk accepting mechanism of any of said at least one apparatuses using said unique mark, said disk accepting mechanism being adapted to read said unique mark from an inserted disk and to identify said inserted disk.

32. The system of claim 31, wherein, after said disk accepting mechanism identifies said inserted disk, the processing means of the apparatus wherein said inserted disk was inserted obtains the transaction information associated with said inserted disk either from the data memory of said apparatus or from the remote processing unit.

33. The system of claim 32, wherein said processing means, based upon transaction information associated with the inserted disk and the date on which the inserted disk is inserted, charges the user one payment if the date on which the disk is inserted is within a preset time period from the date on which the disk was dispensed and charges the user a second, higher payment if the date on which the disk is inserted is beyond the preset time period.

34. The system of claim 32, wherein said processing means, based upon transaction information associated with the inserted disk and the date on which the inserted disk is inserted, charges the user a first payment if the date on which the disk is inserted is within a first preset time period from the date on which the disk was dispensed, charges the user a second payment that is higher than the first payment if the date on which the disk is inserted is beyond the first preset time period but within a second preset time period from the date on which the disk was dispensed, and charges the user a third payment that is higher than the second payment if the date on which the disk is inserted is beyond the second preset time period.

35. The system of claim 31, wherein said unique mark comprises a unique serial number, bar code, encryption, or optical or digital marking.

36. The system of claim 31, wherein said remote processing unit, using said unique mark, is adapted to track each disk throughout all the automated digital media disk vending apparatuses of said system.

37. The system of claim 26, wherein the specific automated digital media disk vending apparatus into which a particular disk containing the selected data title is inserted for return is not necessarily the same apparatus from which the disk was dispensed.

38. The system of claim 26, wherein said remote processing unit, based upon transaction information associated with each dispensed disk and each inserted disk throughout all the automated digital media disk vending apparatuses of said system, calculates royalties due to rightsholders of each selected data title based at least upon the number of times a disk with that selected data title was dispensed from all said apparatuses.

39. The system of claim 26, wherein said processing means of each apparatus accesses transaction information from said data memory regarding at least the frequency of selection of the selected data title from said apparatus and determines, based upon the quantity of disks containing the selected data title in said storage unit of said apparatus, whether a disk containing the selected data title is needed to replace the disk containing the selected data title that was dispensed from said apparatus.

40. The system of claim 26, wherein said remote processing unit accesses transaction information from said data memory of each apparatus regarding at least the frequency of selection of the selected data titles from that apparatus and determines, based upon the quantity of disks containing the selected data titles in said storage unit of that apparatus, whether a disk containing the selected data title is needed to replace the disk containing the selected data title that was dispensed from that apparatus.

41. The system of claim 26, wherein each of said media data titles has a user age minimum limit associated therewith, such that it is desired that a user whose age is below said minimum limit not be dispensed a disk containing that selected data title, and said input from the user regarding said user includes the user's current age.

42. The system of claim 41, wherein said apparatus further comprises an input device for accepting input from the user regarding the age of said user.

43. The system of claim 42, wherein said input device is a magnetic or digital card reader.

44. The system of claim 42, wherein said input device accepts reads information regarding the age of said user from magnetic or digital information on said user's driver's license.

45. The system of claim 41, wherein said processing means, based upon user age minimum limit associated with said selected data title and said input from the user regarding the age of said user, determines whether dispensing of a disk containing said selected data title is permitted.

46. An automated digital media vending apparatus, comprising:
a storage unit containing a plurality of stored disks bearing prerecorded media data titles, each said media data titles having a user age minimum limit associated therewith, such that it is desired that a user whose age is below said minimum limit not be dispensed a disk containing that selected data title;
processing means for processing input from a user regarding the current age of said user and regarding at least one selected data title;
a disk dispensing mechanism for removing a disk containing the selected data title from among said stored disks in said storage unit and for dispensing the disk containing the selected data title to the user;
a data memory for storing transaction information regarding at least the user, the user's current age and the selected data title; and
said processing means, based upon said user age minimum limit associated with said selected data title and said input from the user regarding the age of said user, adapted to determine whether dispensing of a disk containing said selected data title is permitted and either allow a disk containing said selected media title to be dispensed from said apparatus or disallow a disk containing said selected media title from being dispensed from said apparatus.

47. The apparatus of claim 46 further comprising an input device for accepting input from the user regarding the age of said user.

48. The apparatus of claim 47, wherein said input device is a magnetic or digital card reader.

49. The apparatus of claim 47, wherein said input device accepts reads information regarding the age of said user from magnetic or digital information on said user's driver's license.

50. The apparatus of claim 46, wherein said processing means, based upon transaction information associated with each dispensed disk, calculates royalties due to rights-holders of each selected data title based at least upon the number of times a disk with that selected data title was dispensed from said apparatus.

51. The apparatus of claim 46, further comprising a disk recording mechanism for recording selected media data titles onto blank disks, wherein at least some of said plurality of stored disks bearing prerecorded media in the form of various data titles have been pre-recorded by the apparatus itself.

52. The apparatus of claim 51, wherein said processing means accesses transaction information from said data memory regarding at least the frequency of selection of the selected data title and determines, based upon the quantity of disks containing the selected data title in said storage unit, whether a disk containing the selected data title is needed to replace the disk containing the selected data title that was dispensed.
